(19) United States
(12) Patent Application Publication
(10) Pub. No.: US 2018/0032680 A1
(43) Pub. Date: Feb. 1, 2018

(54) STREAMLINED PATIENT COMMUNICATION DEVICE

(71) Applicant: DRFIRST.COM, INC., Rockville, MD (US)

(72) Inventors: James F. CHEN, Naples, FL (US); G. Cameron DEEMER, Mesa, AZ (US); David GIAMBARRESI, Arlington, VA (US)

(21) Appl. No.: 15/224,030

(22) Filed: Jul. 29, 2016

(51) Int. Cl. G06F 19/00

(52) U.S. Cl. CPC G06F 19/322; G06F 19/3456

(57) ABSTRACT

Methods, systems, and programs provide a patient prescription portal that streamlines and improves the process of filling prescriptions. An example method includes determining, responsive to receiving an electronic prescription, that information in the electronic prescription matches a parameter, transmitting, responsive to determining that the information in the electronic prescription matches, a notification to a phone number provided by a patient identified in the electronic prescription, the notification requesting input for managing patient medications, the notification including an opt-in option, and accessing, subsequent to the patient selecting the opt-in option, medication records for the patient. The method may also include initiating a medication app that displays the medication records to the patient and provides controls enabling the patient to change the medication records, receiving, from the patient via the medication app, a change to the medication records, and updating the medication records according to the change.

### TECHNICAL FIELD

Systems and methods relate to electronic prescription systems. More specifically, implementations relate to an improved electronic prescription system that improves patient compliance.

### BACKGROUND

Patients commonly see different physicians for different problems. For example, a patient may see a cardiologist, a psychiatrist, and a primary care physician. Each physician may prescribe different medications for the patient. While physicians commonly ask which medications a patient is taking, the patient may not remember at the start or during the visit the names of one or more of the medications, and patients often forget to follow up after the care event. Moreover, patients sometimes fail to follow through with prescribed medications after a treatment or care event for various reasons, resulting in poor patient outcomes.

### SUMMARY

Systems and methods are provided for initiating communication with patients at the time a new medication is prescribed for a patient. In some implementations, the communication may be initiated when the prescription is entered, e.g., when an electronic prescription is entered by the physician or pharmacist, or when the prescription is processed for a claim by a pharmacy, or when the prescription is adjudicated by a pharmacy benefit manager. Patients tend to be responsive to communications from their physician, especially if such communications are close in proximity to a treatment or care event, so the triggering of the communication responsive to a new prescription increases the likelihood of a patient providing the additional information. In some implementations, the communications may be triggered for specific doctors, for specific patients, or for specific medications. The communications allow the patient to opt-in and enable the patient to confirm and/or change current medications, including legend prescriptions, vitamins, and other over-the-counter medications, and to view the newly prescribed medications, along with additional information related to the prescription such as educational or financial information. This enables the provider to better counsel the patient, to guard against unwanted combinations, and to ensure that the patient has filled and received the recently prescribed medications. While other patient portals exist, these implementations offer a lightweight and convenient outreach for the patient initiated by a specific medical event.

Implementations also enable a patient to direct the outcome of an electronic prescription process. Conventionally, the patient tells the physician where to send the prescription, i.e., the venue, but does not otherwise interact with the electronic prescription process until arriving at the venue to pick up the prescribed medication. However, patients often forget to pick up the medication or the patient at the point of pick-up may find the medication too expensive to purchase. Both options lead to poor patient outcomes. Implementations improve upon the electronic prescription process by enabling the patient to intervene during the electronic prescription process. In other words, implementations enable the patient to interrupt the electronic prescription process to alter the direction of the process. For example, implementations enable the patient to provide current medication information that could cause the physician to alter the recommended medication or dosage. As another example, implementations enable the patient to change the venue, e.g., to obtain a lower cost or to select a more convenient venue, after the prescription has been entered with an original venue. Implementations also enable a patient to request an alternative medication, for example if the prescribed medication is too expensive.

In one aspect, In one general aspect, a method includes receiving an electronic prescription for a patient from a provider, transmitting, responsive to receiving the electronic prescription, a notification to the patient over a wireless communication channel to request input for managing patient medications, the notification including an opt-out option and an opt-in option, obtaining, responsive to the patient selecting the opt-in option, information from the patient that verifies an identity of the patient without generation of a user id, accessing, responsive to obtaining and verifying the information, medication records for the patient, and initiating, over the wireless communication channel, a medication app that displays the medication records to the patient.

In one aspect, a system includes at least one processor and memory storing instructions that, when executed by the at least one processor, cause the system for perform operations. The operations may include determining, responsive to receiving an electronic prescription, that information in the electronic prescription matches a parameter set by a provider of the prescription and transmitting, responsive to determining that the information in the electronic prescription matches the parameter, a notification to a phone number provided by a patient identified in the electronic prescription, the notification including a link unique to the patient and requesting input for managing patient medications, the request occurring over a wireless communication channel and the notification including an opt-in option. The operations may also include accessing, subsequent to the patient selecting the opt-in option, medication records for the patient and initiating, over the wireless communication channel, a medication app that displays the medication records to the patient and provides controls enabling the patient to change the medication records. In some implementations, the operations may also include receiving, from the patient via the medication app, a change to the medication records, and updating the medication records according to the change.

According to one aspect, a system includes at least one processor and memory storing instructions that, when executed by the at least one processor, cause the system to initiate a text message to a patient identified in an electronic prescription, the text message including a link unique to the patient, and generate, responsive to an indication of the patient selecting the link, a user interface. The user interface may be configured to display an identity challenge to the patient, display a newly prescribed medication for the patient, and provide a control for the newly prescribed medication, the control configured to, when selected by the patient, initiate a medication change process to change the newly prescribed medication.

In another aspect, a computer program product embodied on a computer-readable storage device includes instructions that, when executed by at least one processor formed in a substrate, cause a computing device to perform any of the disclosed methods, operations, or processes disclosed herein.

One or more of the implementations of the subject matter described herein can be implemented so as to realize one or more of the following advantages. For example, the patient prescription portal is a quick and easy outreach to the patient after a new prescription event that is easy for the patient to respond to. Implementation on a mobile device makes responding convenient for the patient and increases the response rate and information accuracy. In some implementations, the absence of a user id and password login process increases the patient response rate, as it has been observed that patients are resistant to setting up additional user accounts (e.g., for traditional patient portals). In some implementations, a user id and password can be optional so as to facilitate a long-term relationship with the patient and to allow the patient to provide additional information related to their treatment. Increased patient response and information accuracy enable a physician or other medical professional to better ensure that patients are receiving correct combinations of medications. As another example, patient acceptance of the provider-initiated communication allows the provider to follow the patient and ensures that patient fills and picks up prescriptions. For instance, the patient prescription portal enables a pharmacist to provide medication therapy management. As another example, the patients using the patient prescription portal can save money using discount information, such as coupons, benefit checks, rebates, etc., on new prescriptions that they would not otherwise have knowledge of. As another example, implementations may provide patients with a confirmation that their prescription reached a pharmacy. Such confirmation can expedite prescription retrieval, reduce questions to a physician's office, and improve the patient experience.

The details of one or more implementations are set forth in the accompanying drawings and the description below. Other features will be apparent from the description and drawings, and from the claims.

### BRIEF DESCRIPTION OF THE DRAWINGS

FIG. 1 describes a high level depiction of a system configuration, according to a disclosed embodiment;

FIGS. 2A and 2B illustrate a flowchart of an example process for providing a patient prescription portal, according to a disclosed embodiment;

FIG. 3 illustrates an example invitation to the patient to participate in the prescription portal, according to a disclosed embodiment;

FIG. 4 illustrates an example user interface for verifying patient identity, according to a disclosed embodiment;

FIG. 5 illustrates an example user interface for confirming current medications, according to a disclosed embodiment;

FIG. 6 illustrates an example user interface summarizing past and current prescriptions, according to a disclosed embodiment; and

FIG. 7 illustrates an example user interface for providing discount information related to current prescriptions, according to a disclosed embodiment.

### DETAILED DESCRIPTION

In the following detailed description, numerous specific details are set forth by way of examples in order to provide a thorough understanding of the relevant teachings. However, the relevant teachings may be practiced without such details. In other instances, well known methods, procedures, systems, components, and/or circuitry have been described at a relatively high-level, without detail, in order to avoid unnecessarily obscuring aspects of the disclosure.

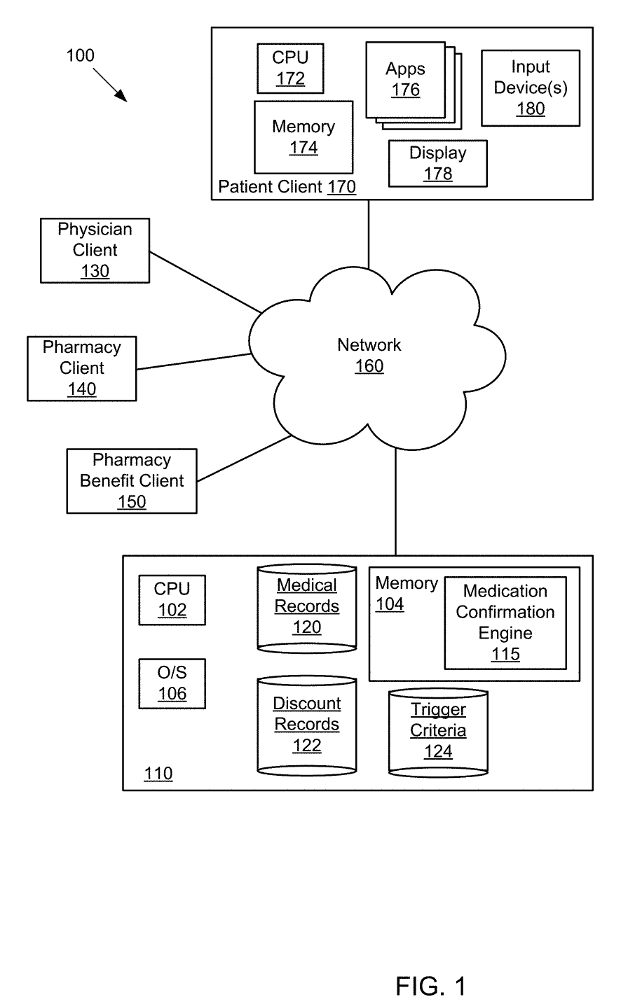

FIG. 1 describes a high level depiction of a patient prescription portal system 100 configuration, according to a disclosed embodiment. The patient prescription portal system 100 may include a medication confirmation server 110. The medication confirmation server 110 may be a computing device or devices that take the form of a number of different devices, for example a standard server, a group of such servers, or a rack server system. In addition, in some implementations server 110 may be implemented in a personal computer or a group of personal computers. The server 110 may include a central processing unit 102, which may be one or more processors formed in a substrate configured to execute one or more machine executable instructions or pieces of software, firmware, or a combination thereof. The processors can be semiconductor-based—that is, the processors can include semiconductor material that can perform digital logic. The server 110 can also include an operating system 106 and one or more computer memories 104, for example a main memory, configured to store one or more pieces of data, either temporarily, permanently, semi-permanently, or a combination thereof. The memory 104 may include any type of storage device that stores information in a format that can be read and/or executed by the central processing unit 102. The memory 104 may include volatile memory, non-volatile memory, or a combination thereof, and store modules that, when executed by the central processing unit 102, perform certain operations. In some implementations, the modules may be stored in an external storage device and loaded into the memory 104 of server 110. In some implementations, the server 110 may be a local installation, a web-based healthcare enterprise system for a healthcare organization, such as, for example, for a hospital or a clinic, or an electronic medical records systems (EMR) for a healthcare provider's office.

The modules may include medication confirmation engine 115. The medication confirmation engine 115 may use medical records 120, discount records 122, and trigger criteria 124 to provide a patient prescription portal to the patient client 170 via network 160. The server 110 may initiate the medication confirmation engine 115 upon receipt of a new prescription from a physician client 130, a pharmacy client 140, and/or a pharmacy benefit client 150. For example, a physician may use physician client 130 to write an electronic prescription via the physician client 130 after an office visit with a patient. In some implementations, the electronic prescription may then become part of medical records 120 for that patient. In some implementations, a pharmacist may use pharmacy client 140 to enter a newly received prescription, whether electronic or paper delivered by the patient. In some implementations, a pharmacy benefit manager (PBM) may initiate medication confirmation engine 115 after receiving a request for payment for a new prescription from the pharmacy. Thus, depending on the implementation, the medication confirmation engine 115 may be triggered by a physician, a pharmacist, or a PBM, which are collectively referred to as the provider. Put another way, the provider, e.g., the entity triggering the medication confirmation engine 115 in response to a new prescription event, may be a doctor, a pharmacist, or a PBM.

In some implementations, the medication confirmation engine 115 may initiate the patient prescription portal in response to a subset of new prescription events. For example, some physicians in a practice may use the portal while others do not. In such a situation, the trigger criteria 124 may indicate that the portal is used for specific prescribing doctors within the practice. As another example, a provider may target some class of patients, e.g., those over 65, those with a certain diagnosis, those taking certain medications, specific patients, etc. In this situation, the trigger criteria 124 may indicate a condition or conditions the patient should meet before initiating the patient prescription portal. As another example, the trigger criteria 124 can identify specific medications or specific patients or a specific practice group.

When a new prescription event meets the triggering criteria, the medication confirmation engine 115 may send an invitation to the patient client 170. The invitation may be a text message to a mobile device of the patient, such as a smart phone, tablet, or wearable device (smart watch, smart glasses, etc.). The invitation may also be an email sent to an account (e.g., email or social media account) of the patient. The phone number or account, which the patient has given to the provider, may be part of the medical records 120. The invitation may provide an opportunity for the patient to opt-in or opt-out of the patient prescription portal. If the patient opts-in, the medication confirmation engine 115 may request that the patient complete an identity challenge before granting full access to the patient prescription portal. The identity challenge may be providing a date, such as a birthdate or anniversary, a passcode, a zip code, a street address, or some other type of information that can be used to verify the identity of the patient without generation of a user id. The patient may have provided this information to the provider. A birthdate based challenge can be sufficient because the patient provided the account or phone information that the invitation is sent to, so the chance that the patient is not the one receiving the invitation is small.

After verifying the identity of the patient, the medication confirmation engine 115 may provide full access to the patient prescription portal. The patient prescription portal is a user interface that enables the patient to confirm or adjust the medications the patient is currently taking, to add additional medications, including over-the-counter medicines and supplements, to view newly prescribed medications, and to obtain discount information (e.g., a rebate, a benefit check, coupon, etc.) related to the new prescriptions. The medication confirmation engine 115 may obtain current medication information for the patient from the medical records 120. However, the current medications from the medical records 120 may be out-of-date and inaccurate. Thus, the patient prescription portal allows the patient to confirm whether the medications in medical records 120 are correct and to add any additional medications, including over-the-counter medications, that the patient is currently taking. This enables the provider, whether a doctor, pharmacist, or PMB, to provide better feedback to the patient, including providing medication therapy management. For example, after the patient has confirmed and adjusted current medications, the provider may adjust dosage or inform the patient to abstain from a particular supplement. In some implementations, when a patient makes any change to the current medication information, the medication confirmation engine 115 may send a notification to the provider. In implementations where the provider is not a physician, the medication confirmation engine 115 may also provide a notification to the physician, where such notification is not prohibited by applicable laws and regulations. Any changes made to the current medications in medication records 120 by the patient via the patient prescription portal may be marked as patient entered. This enables the providers to determine the source of the changes. In some implementations, e.g., where the medical records 120 are not the physician records and where not otherwise prohibited by relevant laws and regulations, the medication conformation engine 115 may ask whether the physician wants to add the changed information to the patient's medical chart in the physician's database.

In addition to enabling the patient to provide current medications, the prescription patient portal may display information about the new prescription event, such as the name and dosage of the medication and where the prescription is being filled. In some implementations, the patient prescription portal may also display the status of the newly prescribed medication, e.g., where the prescription is being filled and whether the patient has picked up the prescription. In some implementations, the medication confirmation engine 115 may be configured to send a reminder to the patient, e.g., as a text message or email, to pick up the medications. In some implementations, the medication confirmation engine 115 may also provide discounts related to the new prescriptions. The discount information may be kept in discount records 122, which can be remotely located from the server 110.

The network 160 may be for example, the Internet or the network 160 can be a wired or wireless local area network (LAN), wide area network (WAN), a cellular network, etc., implemented using, for example, gateway devices, bridges, switches, towers and/or so forth. Via the network 160, the server 110 may communicate with and transmit data to/from clients 130, 140, 150, and 170. In some implementations, patient prescription portal system 100 may be in communication with or include other computing devices that provide updates to the medical records 120, trigger criteria 124, or discount records 122. Financial discounts, in any number of forms, may be provided as an incentive for participation by the patient.

The system 100 also includes patient client 170. The patient client 170 may be any personal computing device, e.g., laptop, tablet, smart phone, cellular phone, smart watch, smart glasses, television with a processor, etc., that is capable of receiving messages, such as text messages, short message service (SMS) messages, secure message service, instant messages, email, etc. In some implementations, the patient client 170 may be a mobile device identified by a phone number or user login. The patient client 170 may include a central processing unit 172, which may be one or more processors formed in a substrate configured to execute one or more machine executable instructions or pieces of software, firmware, or a combination thereof. The processors can be semiconductor-based—that is, the processors can include semiconductor material that can perform digital logic. The patient client 170 can also include an operating system and one or more computer memories 174, for example a main memory, configured to store one or more pieces of data, either temporarily, permanently, semi-permanently, or a combination thereof. The memory 174 may include any type of storage device that stores information in a format that can be read and/or executed by the central processing unit 172. The patient client 170 may also include one or more apps 176. The apps 176 may be mobile applications, e.g., applications downloaded from an app store that perform a specific function. The apps 176 may also include an Internet browser. The patient client 170 may also include a display 178, such as an LCD or LED display, a touch screen display, etc., that displays images and text rendered by the apps 176. The patient client 170 may also include one or more input devices 180, which can include a touch-sensitive display, a mouse, a keyboard (including a keyboard displayed on display 178), etc. The medication confirmation engine 115 may initiate display of the user interfaces that comprise the patient prescription portal displayed on display 178.

The system 100 may also include a physician client 130. The physician client 130 has components similar to those explained with regard to the patient client 170. In addition, the physician client 130 may include an application that communicates with the server 110 and provides new prescription events to the server 110. In some implementations the physician client 130 may trigger the medication confirmation engine 115, e.g., by entering a new e-prescription (electronic prescription) for a patient. The physician client 130 may also be used to receive information from the server 110 (e.g., notifications or updated medical records). In some implementations, the server 110 and the physician client 130 may be part of a client-server system.

The system 100 may also include a pharmacy client 140. The pharmacy client 140 has components similar to those explained with regard to the patient client 170 and the physician client 130. The pharmacy client 140 may be a personal computing device used by the pharmacist filling a new prescription. Thus, in some implementations, the pharmacy client 140 may trigger the medication confirmation engine 115 and the provider may be the pharmacist. The pharmacy client 140 may thus be in communication with the server 110 and/or the physician client 130 and may run applications that enable the pharmacy client 140 to receive data from and send data to the server 110 and/or physician client 130. In some implementations, the server 110 and the pharmacy client 140 may be part of a client-server system, e.g., a web-based pharmacy system or a web-based enterprise healthcare system.

The system 100 may also include a pharmacy benefit client 150. The pharmacy benefit client 150 has components similar to those explained with regard to the patient client 170, the physician client 130, and the pharmacy client 140. The pharmacy benefit client 150 may be a personal computing device used by a PBM to adjudicate new prescription requests. In other words, the pharmacy benefit client 150 may trigger medication confirmation engine 115 when a request to adjudicate a new prescription arrives. Thus, in some implementations, the PBM may be the provider. The pharmacy benefit client 150 may thus be in communication with the server 110, the physician client 130 and/or the pharmacy client 140. Although illustrated with specific components in FIG. 1, system 100 may include additional components not illustrated, or may not include all elements shown. In some implementations, the server 110 and the pharmacy benefit client 150 may be part of a client-server system, e.g., a web-based healthcare system.

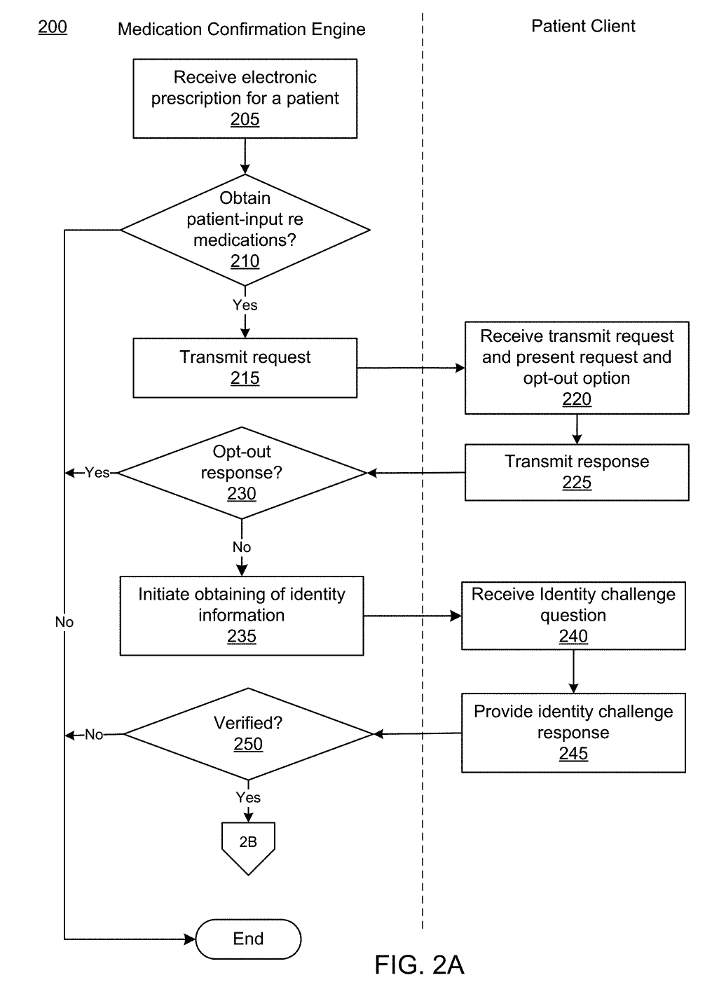

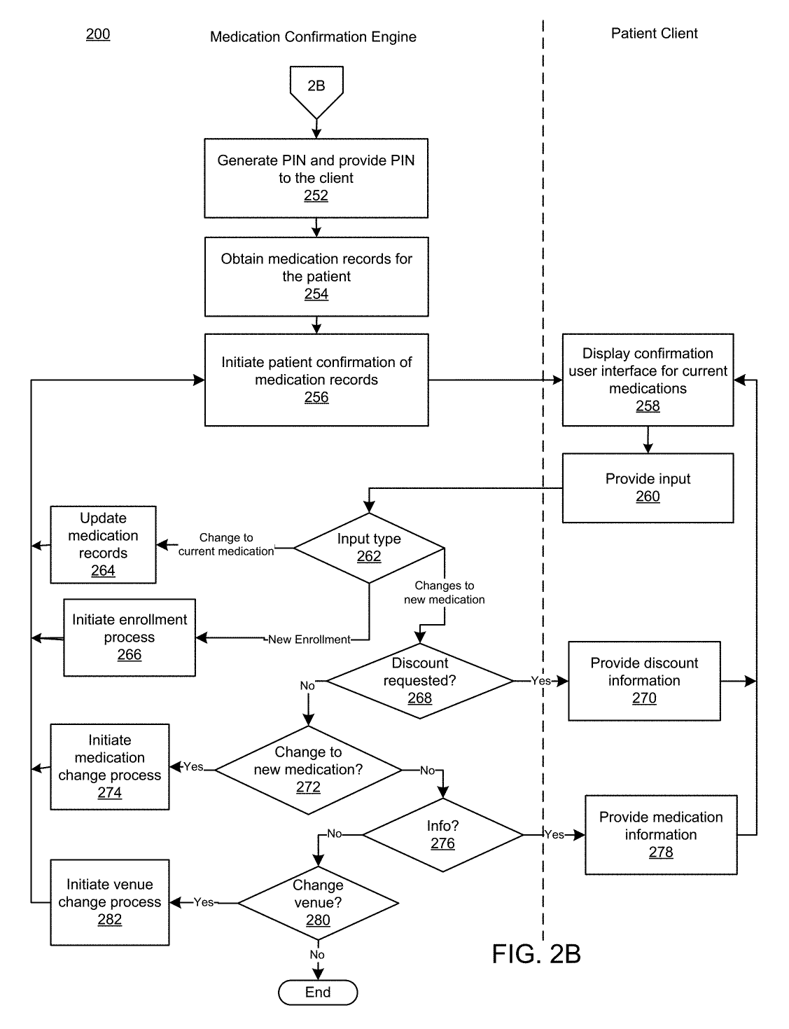

FIGS. 2A and 2B illustrate a flowchart of an example process 200 for providing a patient prescription portal, according to a disclosed embodiment. The patient prescription portal may be an example of a medication app, which can be a web application (e.g., a program run via the server and accessed via a browser on a client) or a mobile application (e.g., a program run on the client that accesses information on a server). Process 200 may be executed by, for example, a patient prescription portal system, such as system 100 of FIG. 1. Process 200 may enable a physician, pharmacist, or PBM, i.e., a provider, to initiate communication with a patient in response to a new prescription event. The communication is designed to be quick and easy, minimizing the input required by the patient to increase the likelihood that the patient will participate. The communication may also be targeted based on criteria set up by the provider. In other words, the communication may not be initiated for every patient and/or every prescription for a particular patient.

Process 200 may begin when the system receives an electronic prescription for a patient (205). Receiving the electronic prescription may occur when a physician enters the electronic prescription, when a pharmacist enters a new prescription, or when a prescription is submitted to a PBM for approval. These events may collectively be referred to as a new prescription event. When a physician enters a new prescription the physician is the provider. When a pharmacist enters the prescription the pharmacist is the provider. When the submission of the prescription to a PBM triggers the prescription event, the PBM is the provider. Implementations may include one or more of these types of providers and new prescription events as part of step 205.

The system may determine whether to obtain patient input for this new prescription event (210). For example, the provider may determine that information is needed only for certain medications (e.g., the medication indicated in the new prescription event), only for a certain class of patient, or only for certain physicians (e.g., the physician prescribing the medication in the new prescription). The system may use trigger criteria to make the determination. In some implementations, the trigger criteria may be customized or set by the provider or a practice group that includes the provider. In some implementations, step 210 is optional and patient input is obtained for all new prescription events.

When patient input is not obtained (210, No), process 200 ends for this new prescription event. Put another way, no patient prescription portal is initiated when the new prescription fails to match a trigger. When patient input is to be obtained (210, Yes), the system may transmit a request or invitation to the patient (215). The request may be transmitted to a device or account identifier supplied by the patient. For example, the system may send a text message to a phone number provided by the patient. As another example, the system may send a text message to a user account (e.g., an APPLE ID or GOOGLE HANGOUT ID). As another example, the system may send an email message to the patient. The request may be received by the patient client, which may present the invitation via an application (220). The invitation may include a link or other control that is unique to the patient. This link may represent an opt-in option. In some implementations, the invitation may also include an opt-out option. The invitation may be valid for a limited period of time, for example, a day, two days, twelve hours, three days, etc.

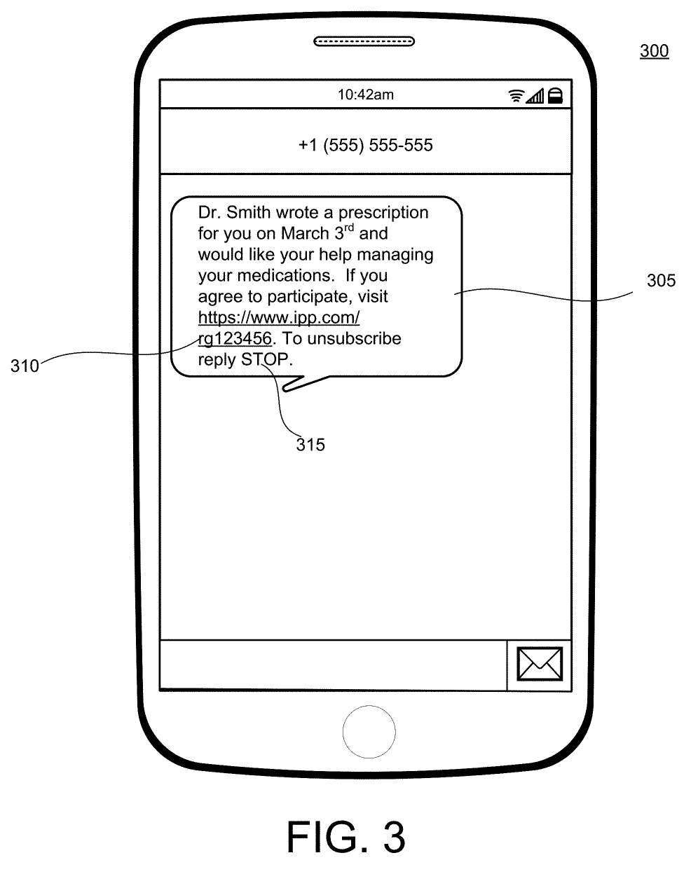

FIG. 3 illustrates an example invitation to the patient to participate in the patient prescription portal, according to a disclosed embodiment. The invitation 305 in the example of FIG. 3 is illustrated as a text message sent to a mobile phone, but invitations are not limited to text messages sent to a phone number. The invitation in part of a user interface 300 that may provide the patient an opportunity to opt-in to the patient prescription portal. For example, the invitation may include a link 310 generated specifically for the patient. In other words, the link 310 may be unique to the patient, either because the address in the uniform resource locator (URL) is unique to the patient or because a parameter in the URL makes the link unique to the patient. The link 310 thus represents an opt-in option. In some implementation, this personalized link may be valid for a limited period of time, after which the patient can no longer use the link to access the system. In some implementations, the invitation may also include an opt-out option 315. The opt-out option 315 may be a way for the patient to indicate a desire not to receive invitations in the future. If the patient uses the opt-out option 315 the system may update the trigger criteria (e.g., trigger criteria 124 of FIG. 1) so that the system will not obtain input from the patient for future new prescription events for this patient.

Returning to FIG. 2A, the patient may provide a response to the invitation (225), which is transmitted via a wireless communication channel, to the medication confirmation engine. Process 200 cannot continue if the patient does not respond at all to the invitation. The system may then determine whether the patient selected the opt-out option in the invitation (230). If so, (230, Yes), process 200 ends. Otherwise (230, No), the system may initiate a process to obtain information that can confirm the identity of the patient (235). Because the phone number or account has been provided by the patient, there is a high likelihood that the intended recipient received the invitation. However, some patient devices may be shared, e.g., by members of the same household, so the system may employ a secondary identity factor. The secondary identity factor may be an identity challenge question, e.g., in the form of a date, number, or password that the patient is likely to remember. The patient may have provided the answer to the challenge as part of a new patient intake process. The patient client may receive the identity challenge question and may present the question via an application user interface (240).

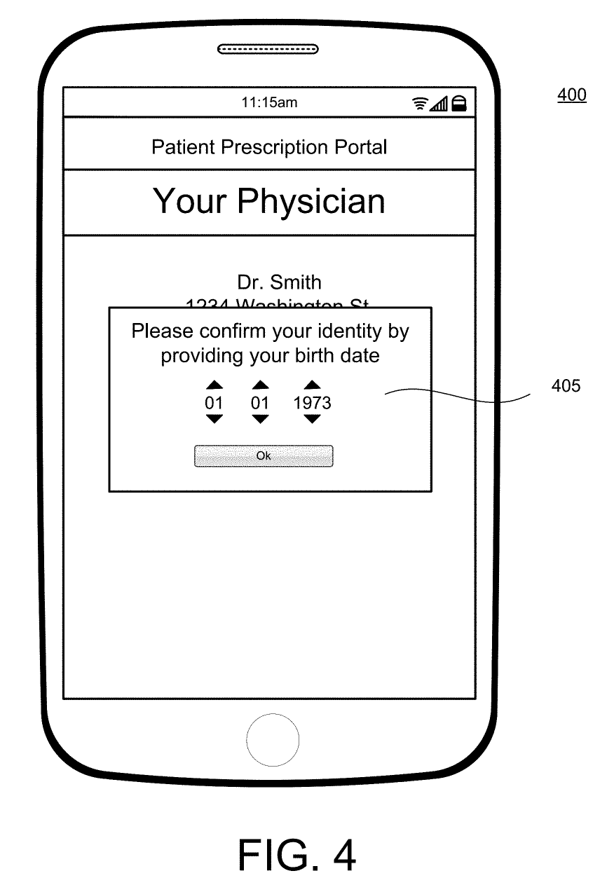

FIG. 4 illustrates an example user interface 400 for verifying patient identity, according to a disclosed embodiment. User interface 400 may be an initial screen in a medication app, e.g., the patient prescription portal, which can be a mobile application or a web application. In some implementations, the web application may be optimized for mobile browsing. The user interface 400 includes an identity challenge question 405 designed to ensure that the individual responding to the invitation is the intended recipient of the invitation. In the example of FIG. 4, the identity challenge question 405 is a birthdate. In other implementations, the identity challenge question may be a wedding anniversary, a graduation date, street address information, a security question, etc. The identity challenge question should be some item of information the patient does not need to look up, as this may discourage use of the patient prescription portal.

Returning to FIG. 2A, the patient may provide the response to the identity challenge (245), which is transmitted from the medication app via a wireless connection to the medication confirmation engine. The system may then determine whether or not the patient provided a verified response to the identity challenge question (250). If not (250, No), process 200 ends. Otherwise (250, Yes), the system may initiate display of the patient prescription portal information for the patient.

Turning to FIG. 2B, the system may generate a PIN (personal identification number) and provide the PIN to the patient (252). The patient may use the PIN to access the system without a username or password for the remainder of the time period for which the invitation (e.g. the link 315) is valid. After the time period, i.e., when the invitation is not valid, the PIN will not allow access. However, the system may provide a way for the patient to create a non-temporary login, such as a user name and password, that provides ongoing access to the system. For example, the system may include an input that requests enrollment in a patient portal (262, “New Enrollment”) that initiates an enrollment process (266) that includes generation of a user account, e.g., a user id and password. Once a non-temporary login is generated the system allows the patient access beyond the time period for which the invitation is valid. The system may obtain medication records for the patient (254). The medication records may be records kept by the physician's practice group if the provider is a physician, may be records kept by the pharmacy if the provider is a pharmacist, or may be records kept by the PBM if the provider is a PBM. In any case, the records may not be complete because the provider lacks information about other medications that patient has taken or is now taking. This is true for a variety of reasons, such as patients seeing more than one doctor for different medical conditions, patients using multiple pharmacies, patients having more than one health insurance provider, patients recently switching physicians, pharmacies, or health insurance providers, etc. The system may initiate patient confirmation of the medication records (256). For example, the system may generate a user interface for display on the patient client device or the system may provide data to the patient client device, which may generate the user interface. The client device may display the confirmation user interface that the patient can use to confirm current medications (258). The user interface may have several sections, which can be implemented in one user interface or in a series of windows that make up the user interface. The user interface may allow the patient to confirm or change (i.e., delete from or add to) the medications that the patient is currently taking.

For example, the user interface may provide controls that enable the patient to delete medications that the medical records indicate the patient is currently taking. The user interface may also include a control that enables the patient to add additional medications, including supplements and vitamins, to the medical records. The user interface may also provide a control that enables the patient to view past medications and to select one or more of the past medications to add to current medications. Any one of these actions may be input provided to the medication confirmation engine (260) that change the current medications in the medical records (262, Change to current medication). Accordingly, the system may update the medication records (264). Any changes that the patient makes to current medications the system may designate in the medical records as patient entered. Thus the provider may be able to determine the source of the changes. In some implementations, for example where the medical records are not kept by the prescribing physician, the system may provide the updated information to the prescribing physician, where providing such information is in accordance with any applicable laws or regulations. In some implementations, the system may request a reason for the change. For example, if the patient deleted a medication the system may ask the patient to indicate why the medication was discontinued. Similarly, if the patient re-adds a previously discontinued medication the system may ask the patient to indicate why the medication was restarted.

Once a change is recorded, the system may display the updated patient prescription portal, e.g., by initiating patient confirmation of the updated medication records (256). Thus, the patient may continue to make additional changes. In addition to providing changes to the medication records, the user interface may include other controls that enable the patient to provide input (260). If the input is not a change to the current medications, it may be new medication activity (262, “New medication activity”). The new medication activity may be a request for a discount that can be applied to one or more of the medications in the new prescription event (268, Yes). For example, the system may include discount information that can help offset the cost of filling a new prescription. If a discount is requested and applies to the medication identified in the new prescription event (268, Yes), the system may display the discount information to the patient (270), e.g., via a window in the patient prescription portal. The patient may show the discount information to a pharmacist, email the discount information, text the discount information, and/or print the discount (e.g., a coupon or check), depending on the implementation. The system may return to the new medication user interface, e.g., via (258).

If the new medication activity is not a discount request (268, No), it may be a change request (272, Yes). A change request enables a patient to request a substitution for a medication within the benefit plan of which the patient is a member. For example, the patient may request a generic rather than a branded medication, may request another medication within the therapeutic class of the prescribed medication, or may request another type of substitution allowed under the plan. In some implementations, the system may provide prices for the alternatives to the prescribed medications. In some implementations, the price may be dependent on the venue currently selected to fill the prescription. If a patient wants to change a new medication (272, Yes), the system may initiate a medication change process (274). For example, the system may send a secure message or fax to the pharmacy filling the prescription, to the prescribing physician, or both. The message may request approval or conformation of the change. The system may use any industry standard for the messaging. Once a change is recorded, the system may display the patient prescription portal, e.g., by initiating patient confirmation of the updated medication records (256).

If the new medication activity is not a change to a new medication (272, No), it may be a request for information about a new medication (276, Yes). The information may be provided (278) as link, a secure message, a email message, or as a document. The information can include information about the medication that is typically provided as printed material when the medication is picked up from the pharmacy. The user may then return to the new medication user interface (e.g., via (258).

If the new medication activity is not a request for information (276, No), the activity may be a change in venue (280). The venue is the way the patient receives the medication. The venue may refer to a particular pharmacy, to home delivery by the pharmacy, or to mail order delivery. The patient may change the venue by changing pharmacies, by changing to home delivery, by changing to mail order, or by changing back from home delivery or mail order to pharmacy pick-up. The system may initiate a venue change process and the system may display the patient prescription portal, e.g., by initiating patient confirmation of the updated medication records (256). The patient may end the user interface at any time by providing an exit intent (not illustrated). Process 200 then ends.

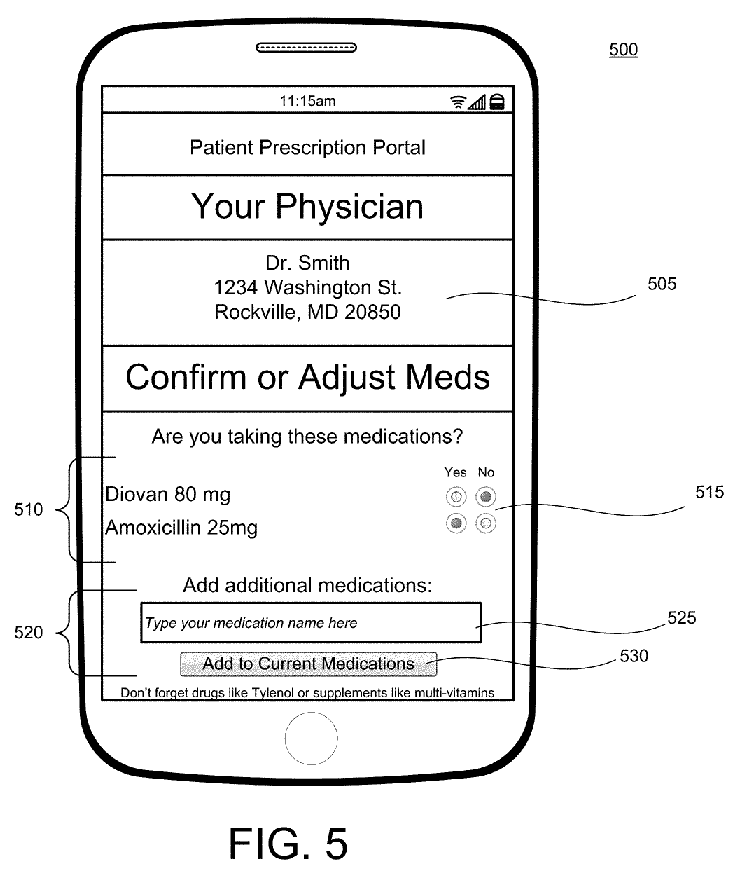

FIG. 5 illustrates an example user interface 500 for confirming current medications, according to a disclosed embodiment. The user interface 500 is an example of a user interface in a medication app that a patient can use to change current medications as part of process 200. In the example of FIG. 5 the user interface 500 includes information about the provider 505. This provider information 505 may be used to give the patient confidence that the medication records are tried to the invitation received. In some implementations (not shown), the user interface 500 may include a control that enables the patient to verify that the information displayed in the user interface is recognized by the patient as belonging to the patient. If the patient fails to confirm, the system may close the user interface 500.

The user interface 500 also includes a portion 510 that displays medications that the medication records indicate that the patient is currently taking. The portion 510 may include controls 515 that enable the patient to confirm (e.g., via the “Yes radio button) or delete (e.g., via the ‘No’ radio button) any of the medications listed in the portion 510. Selecting one of the controls 515 may cause the user interface to provide input to the medication confirmation engine, e.g., as part of step 260 of FIG. 2B. In some implementations, when a patient deletes a medication the system may request the reason the medication was stopped, for example via a pop-up window or text box. The user interface 500 may also include a second portion 520 that enables the patient to add medications to the medical records. For example, the patient may type the name of the medication and dosage into the text box 525 and submit the text via control 530. This information may also be input provided as part of step 260 of FIG. 2B. In some implementations the first portion 510 and the second portion 520 may be different windows of the user interface 500. In the example of FIG. 5, the first portion 510 and the second portion 520 are accessed by scrolling down.

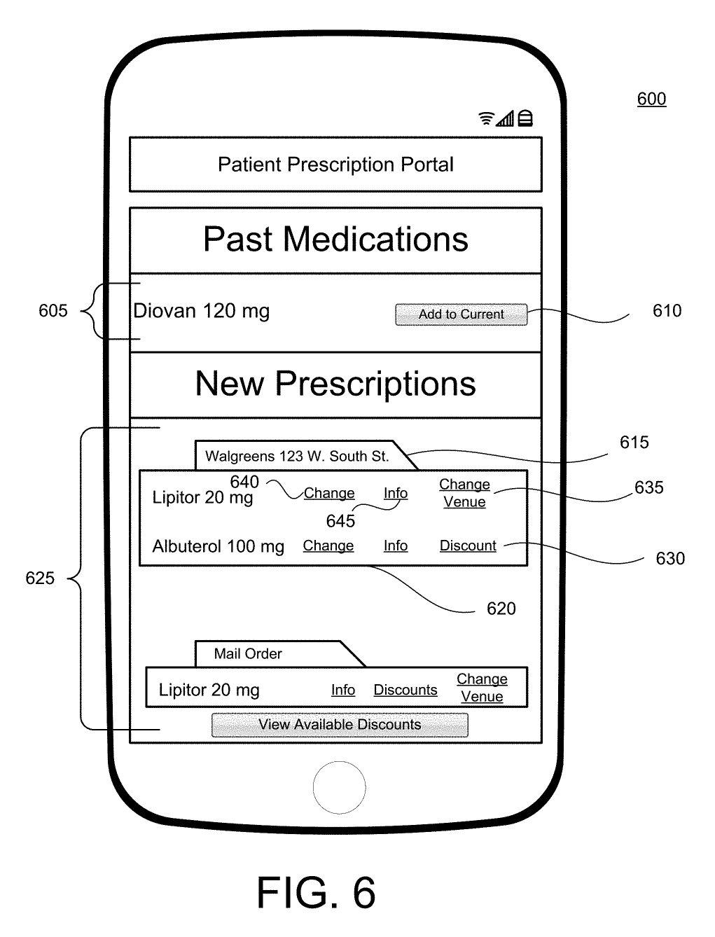

FIG. 6 illustrates an example user interface 600 that summarizes past and new prescriptions, according to a disclosed embodiment. In some implementations, the patient may navigate from user interface 500 to user interface 600. In one implementation, the patient may navigate by scrolling the user interface 500 of FIG. 5. In other words, user interface 600 may be a continuation of or another portion of the user interface 500 of FIG. 5 accessed by scrolling down. In another implementation, some or all of the information displayed in user interface 600 may be presented in a user interface distinct from user interface 500. In other words, the patient may use a “next” link, button, or other control to access user interface 600. User interface 500 and user interface 600 are both considered part of the patient prescription portal.

The user interface 600 may include a portion 605 that displays past medications from the medical records from the patient. The past medications may have been removed from the current medications list by the patient or the provider. The past medications portion 605 may have a control 610 that enables the patient to re-add the medication to the current medications. In other words, the patient may have stopped a vitamin or other medication for a time, but is now taking that medication again. Providing control 610 helps the patient add the medication back to the list of current medications using one click rather than a text input (e.g., via text box 525). Selecting the control 610 is another example of input provided in step 260 of FIG. 2B.

The user interface 600 may also include information 625 about the medications in the new prescription event. The medications listed in information 625 may be the medications that triggered the patient prescription portal (e.g., from step 205 of FIG. 2A). In addition to the name and dose of the medication 620 the information 625 may include the venue 615 filling the prescription or dispensing the medication. In some implementations, the venue 615 may include a navigation aid. For example, the name of the venue 615 may be a selectable link that opens a map application to the address of the venue 615. In some implementations, the user interface 600 may include a control for changing the venue 615. For example, the user interface may include control 635 that enables a patient to request the medication 620 be filled via home delivery, via mail order, or transferred to another pharmacy. The user interface may include, where applicable, a discount control 630 that enables the patient to access discount information applicable to the medications in the new prescription event (e.g., in information 625). Selecting discount control 630 is another example of input provided by the patient as part of step 260 of FIG. 2B. The discount may be anything that reduces the out-of-pocket cost for the patient. The system may provide coupons as an incentive to provide the information requested in the patient prescription portal. If no discounts apply to the medication the system may lack discount control 630 for that medication.

The user interface may also include the ability for the patient to request changes to their new prescription. For example, the user interface may include change control 640. Change control 640 may enable a patient to request a change in the medication prescribed, e.g., within the benefit plan of which the patient is a member. For example, the patient may request a generic rather than a branded medication, or may request another type of substitution allowed under the plan. This ability represented by change control 640 enables the patient to make decisions and be involved in their benefits plan. Not all new medications may be eligible for a change and such medications may lack a control 640 (e.g., the Lipitor 20 mg medication illustrated in FIG. 6). If a patient selects control 640, the system may send a secure message or fax to the venue (e.g., the pharmacy) or the prescribing physician. The message may request approval or conformation of the change. The system may use any industry standard for the messaging.

In some implementations, the user interface may include an information control 645. The information control 645 may be a link to information about the medication (e.g., directions on how to administer, side effects, warnings, etc.) that is typically provided as printed material when the medication is picked up from the pharmacy. In some implementations, the medication information may be delivered electronically to the patient in another form (e.g., email, secure message, etc.). In some implementations, the new prescription information may be tracked by the provider. For example, if the patient has not yet picked up the prescribed medication 620 from the pharmacy, the system may send a reminder to the patient to pick up the medication and/or to adhere to the prescribed therapy.

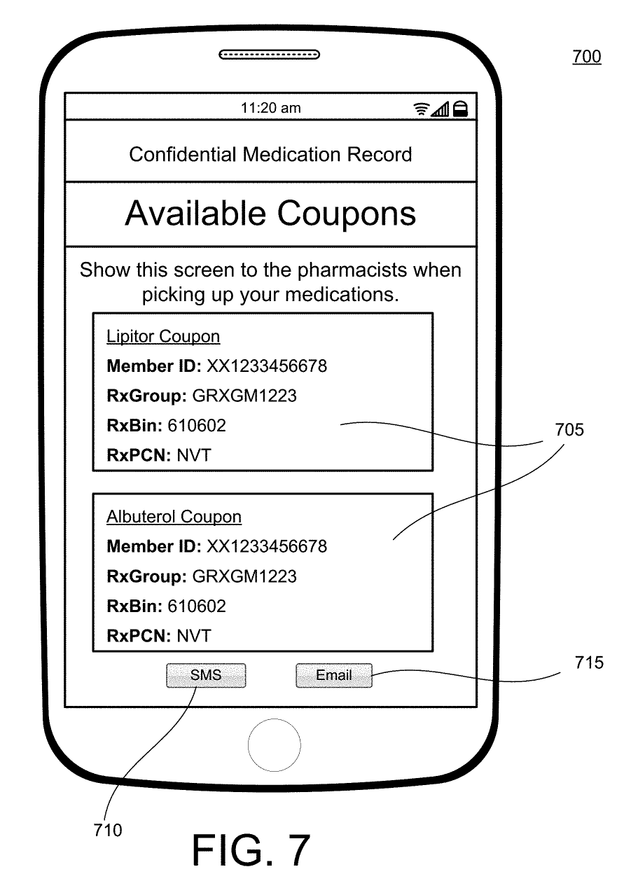

FIG. 7 illustrates an example user interface 700 for providing a discount in the form of a coupons related to current prescriptions, according to a disclosed embodiment. The user interface 700 may be triggered when the patient selects the coupon control 630 of FIG. 6. The user interface 700 is an example of displaying coupon information as part of step 290 of FIG. 2B. User interface 700 is one example of displaying such information and implementations may include other methods or displays with different or additional information. For example, in some implementations, the coupon information may be presented via an email or text message sent to the patient. The user interface 700 may display one or more coupons 705 that apply to one or more of the medications in the current prescriptions. The patient can use interface 700 to show the pharmacist the coupon information. In some implementations, the interface 700 may include other ways for the patient to provide the coupon to the pharmacist, for example, via a text message activated by text message control 710 or via an email activated by email control 715. User interfaces 500, 600, and 700 are provided as examples but implementations are not limited to the exact elements illustrated.

In addition to the configurations described above, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.)—collectively referred to as hardware processor(s), to achieve the functions or operations being described. The functions of embodiments described can be implemented in any type of apparatus that can execute instructions or code.

More particularly, programming or configuring or causing an apparatus or device, for example, a computer, to execute the described functions of embodiments creates a new machine where in case of a computer a general purpose computer in effect becomes a special purpose computer once it is programmed or configured or caused to perform particular functions of the embodiments pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

Those skilled in the art will recognize that the present teachings are amenable to a variety of modifications and/or enhancements. For example, the patient prescription portal and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

In one general aspect, a method includes receiving an electronic prescription for a patient from a provider, transmitting, responsive to receiving the electronic prescription, a notification to the patient over a wireless communication channel to request input for managing patient medications, the notification including an opt-out option and an opt-in option, obtaining, responsive to the patient selecting the opt-in option, information from the patient that verifies an identity of the patient without generation of a user id, accessing, responsive to obtaining and verifying the information, medication records for the patient, and initiating, over the wireless communication channel, a medication app that displays the medication records to the patient.

These and other aspects may include one or more of the following features. For example, the method may also include determining, responsive to receiving the electronic prescription, whether to receive patient input for managing patient medications, the determining being based on parameters et by a provider of the prescription, wherein the transmitting occurs when it is determined to receive patient input. In some implementations, determining whether to receive patient input can include determining that the electronic prescription is for a particular medication identified in the parameters, determining that the electronic prescription is for a particular patient identified in the parameters, determining that the electronic prescription was requested by a particular practice identified in the parameters, and/or determining that the electronic prescription was requested by a particular provider in a particular practice identified in the parameters.

As another example, the notification may be a text message that includes a link unique to the patient. In some implementations, the link may expire after a predetermined time period. As another example, a physician prescribing the electronic prescription may be provided with a notification identifying the patient and the new medication. As another example, the method may also include providing an option to display a discount for at least one medication in the electronic prescription. As another example, the method may also include receiving, from the patient, a confirmation of a medication included in the medication records, receiving, from the patient via the medication app, at least one new medication, and updating the medication records with the new medication.

In one general aspect, a system includes at least one processor and memory storing instructions that, when executed by the at least one processor, cause the system for perform operations. The operations may include determining, responsive to receiving an electronic prescription, that information in the electronic prescription matches a parameter set by a provider of the prescription and transmitting, responsive to determining that the information in the electronic prescription matches the parameter, a notification to a phone number provided by a patient identified in the electronic prescription, the notification including a link unique to the patient and requesting input for managing patient medications, the request occurring over a wireless communication channel and the notification including an opt-in option. The operations may also include accessing, subsequent to the patient selecting the opt-in option, medication records for the patient and initiating, over the wireless communication channel, a medication app that displays the medication records to the patient and provides controls enabling the patient to change the medication records. In some implementations, the operations may also include receiving, from the patient via the medication app, a change to the medication records, and updating the medication records according to the change.

These and other aspects may include one or more of the following features, alone or in combination. For example, the operations may also include initiating, responsive to the patient selecting the opt-in option, an identity challenge question via the medication app, wherein accessing the medication records occurs responsive to receiving a successful response to the identity challenge question and without creation of a user id. As another example, the operations may include initiating, responsive to updating the medication records, a notification to the provider identifying the change. As another example, the provider may be a pharmacy benefit manager (PBM). As another example, the operations may include receiving, from the patient via the medication app, a request to change to the medication identified in the electronic prescription, and initiating a notification to the provider identifying the request, the notification being initiated prior to the electronic prescription being filled.

As another example, the parameter set by the provider may identify one or more patients and determining that the information in the electronic prescription matches a parameter set by a provider of the prescription includes matching the patient identified in the electronic prescription to the one or more patients identified by the parameter. As another example, the parameter set by the provider may identify one or more medications and determining that the information in the electronic prescription matches a parameter set by a provider of the prescription includes matching a medication identified in the electronic prescription to the one or more medications identified by the parameter. As another example, the parameter set by the provider may identify one or more physicians and determining that the information in the electronic prescription matches a parameter set by a provider of the prescription includes matching a physician identified in the electronic prescription to the one or more physicians identified by the parameter. As another example, the parameter set by the provider may identify a class of patients and determining that the information in the electronic prescription matches a parameter set by a provider of the prescription includes determining that the patient identified in the electronic prescription is a member of the class.

In one general aspect, a system includes at least one processor and memory storing instructions that, when executed by the at least one processor, cause the system to initiate a text message to a patient identified in an electronic prescription, the text message including a link unique to the patient, and generate, responsive to an indication of the patient selecting the link, a user interface. The user interface may be configured to display an identity challenge to the patient, display a newly prescribed medication for the patient, and provide a control for the newly prescribed medication, the control configured to, when selected by the patient, initiate a medication change process to change the newly prescribed medication.

These and other aspects may include one or more of the following features. For example, the identity challenge may be a date associated with the patient. As another example, the user interface may further be configured to provide a discount for the newly prescribed medication. As another example, the control is a first control and the user interface is further configured to provide a second control for the newly prescribed medication, the second control configured to, when selected by the patient, initiate a change in venue for the newly prescribed medication and/or the user interface may be further configured to provide a second (or third) control configured to, when selected by the patient, initiate display of medication information for the newly prescribed medication.

1. A method for displaying medication information for a patient on a graphical user interface (GUI), the medication information stored in medical records of a data store, and for updating the medical records via the graphical user interface, the method comprising:
displaying an initial user interface of the GUI on a mobile device associated with a phone number for the patient, the initial user interface being displayed responsive to selection of a personal link in a time-sensitive message sent to the mobile device, the message being sent responsive to generation of a new electronic prescription event for the patient, the initial user interface having an identity challenge question region and a response entry region, the initial user interface lacking a non-temporary login; and
displaying a secondary user interface of the GUI responsive to receiving, via a wireless communication channel, an indication of successful verification of a response provided in the response entry region, the secondary user interface including:
a current medication region having, for each medication indicated as current in the medical records, a first control for confirming, by the patient, the medication as current,
a medication entry region for receiving at least one new medication, and
a new prescription region, the new prescription region including, for each of one or more medications associated with the new electronic prescription event:
a second control that, when selected, requests a change of the medication, and
a third control that, when selected, changes a venue for the medication,
wherein responsive to selection of one or more of the first control, the second control, or the third control, respective medical records in the data store for the patient are updated and a notification is sent to a provider of the electronic prescription that identifies the change.

2. The method of claim 1, wherein the time-sensitive message is sent to the mobile device responsive to receiving the electronic prescription and determining that attributes of the electronic prescription match parameters set by the provider.

3. The method of claim 2, wherein determining that attributes of the electronic prescription match the parameters set by the provider includes:
determining that the electronic prescription is for a particular medication identified in the parameters.

4. The method of claim 2, wherein determining that attributes of the electronic prescription match the parameters set by the provider includes:
determining that the electronic prescription is for a particular patient identified in the parameters.

5. The method of claim 2, wherein determining that attributes of the electronic prescription match the parameters set by the provider includes:
determining that the electronic prescription was requested by a particular practice identified in the parameters.

6. The method of claim 2, wherein determining that attributes of the electronic prescription match the parameters set by the provider includes:
determining that the electronic prescription was requested by a particular provider in a particular practice identified in the parameters.

7. The method of claim 1, wherein the time-sensitive message is a text message that includes a link unique to the patient.

8. The method of claim 7, wherein the link expires after a predetermined time period.

9. The method of claim 1, wherein the provider is a physician prescribing the electronic prescription.

10. The method of claim 1, the secondary user interface further including a fourth control that, when selected, displays: display a discount for at least one medication in the electronic prescription.

11. The method of claim 1, wherein the identity challenge question region displays a birthdate prompt and the response entry region is configured to receive a date.

12. A system comprising:
at least one processor; and
memory storing instructions that, when executed by the at least one processor, cause the system for perform operations including:
determining, responsive to receiving an electronic prescription, that information in the electronic prescription matches a parameter set by a provider of the prescription,
transmitting, responsive to determining that the information in the electronic prescription matches the parameter, a time-sensitive notification to a phone number provided by a patient identified in the electronic prescription, the notification including a link unique to the patient and requesting input for managing patient medications, the request occurring over a wireless communication channel and the notification including an opt-in option,
providing, subsequent to the patient selecting the opt-in option, an initial user interface to be displayed on the mobile device that includes an identity challenge question region and a response entry region, the initial user interface lacking an association with a user account,
verifying, subsequent to receiving a response in the response entry region, whether the response matches information for the electronic prescription,
accessing, subsequent to verifying that the response matches the information, medication records for the patient,
displaying, over the wireless communication channel, a secondary user interface having a first display region that displays the medication records to the patient and provides controls enabling the patient to change information in the medication records and a second display region that displays the medication identified in the electronic prescription and includes a control that enables the patient to change the medication identified in the electronic prescription,
receiving, from the patient via the medication app, selection of the control that enables the patient to change the medication identified in the electronic prescription, and
providing a notification to the provider identifying the change, the notification being initiated prior to the electronic prescription being filled.

13. The system of claim 12, wherein the memory further stores instructions that, when executed by the at least one processor, causes the system to perform operations including initiating, responsive to the patient selecting the opt-in option, an identity challenge question via the medication app, wherein accessing the medication records occurs responsive to receiving a successful response to the identity challenge question and without creation of a non-temporary login.

14. The system of claim 12, wherein the parameter set by the provider identifies one or more patients and determining that the information in the electronic prescription matches the parameter set by the provider of the prescription includes matching the patient identified in the electronic prescription to the one or more patients identified by the parameter.

15. The system of claim 12, wherein the parameter set by the provider identifies one or more medications and determining that the information in the electronic prescription matches the parameter set by the provider of the prescription includes matching a medication identified in the electronic prescription to the one or more medications identified by the parameter.

16. The system of claim 12, wherein the parameter set by the provider identifies one or more physicians and determining that the information in the electronic prescription matches the parameter set by the provider of the prescription includes matching a physician identified in the electronic prescription to the one or more physicians identified by the parameter.

17. The system of claim 12, wherein the parameter set by the provider identifies a class of patients and determining that the information in the electronic prescription matches the parameter set by the provider of the prescription includes determining that the patient identified in the electronic prescription is a member of the class.

18. The system of claim 12, wherein the memory further stores instructions that, when executed by the at least one processor, causes the system to perform operations including:
receiving, from the patient via the medication app, a change to the medication records;
updating the medication records according to the change; and
initiating a notification to the provider identifying the change.

19. The system of claim 12, wherein the memory further stores instructions that, when executed by the at least one processor, causes the system to perform operations including:
receiving, from the provider, authorization to make the change; and
updating the electronic prescription to reflect the change.

20. A system comprising:
at least one processor; and
a graphical user interface (GUI) accessed responsive to selection of a personal link in a time-sensitive text message sent to a mobile device associated with a phone number for a patient responsive to a new electronic prescription event, the user interface facilitating accuracy of medical records for the patient, the user interface including:
an initial user interface of the GUI having an identity challenge region with an identity challenge question directed to the patient and a response entry region, the initial user interface lacking an association with a non-temporary login,
a secondary user interface of the GUI displayed responsive to a successful verification of a response provided by the patient in the response entry region, the secondary user interface including:
a current medication region including, for each medication indicated as current in the medical records, a first control for confirming, by the patient, the medication as current,
a medication entry region for receiving an additional medication, and
a new prescription region, the new prescription region including, for each of one or more medications associated with the new electronic prescription event:
a second control that, when selected, requests a change of the medication, and
a third control that, when selected, changes a venue for the medication,
wherein, responsive to selection of one or more of the first control, the second control, or the third control, respective medical records for the patient are updated and a notification identifying the updated records is sent to a physician associated with the new electronic prescription event.

21. The system of claim 20, wherein the identity challenge question region requests a date associated with the patient.

22. The system of claim 20, where the new prescription region further includes:
a third control that, when selected, displays a discount for the medication.

23. The system of claim 21, wherein the date is an anniversary of the patient.

24. The system of claim 20, where the secondary user interface further includes:
a past medication region for listing expired medications.
